(19) United States
(12) Patent Application Publication
(10) Pub. No.: US 2025/0074052 A1
(43) Pub. Date: Mar. 6, 2025

(54) LIQUID EJECTION HEAD AND LIQUID EJECTION APPARATUS

(71) Applicant: CANON KABUSHIKI KAISHA, Tokyo (JP)

(72) Inventor: RYOTARO MURAKAMI, Kanagawa (JP)

(21) Appl. No.: 18/819,688

(22) Filed: Aug. 29, 2024

(30) Foreign Application Priority Data
Aug. 31, 2023 (JP) 2023-140802

(51) Int. Cl. B41J 2/14

(52) U.S. Cl. CPC B41J 2/14024; B41J 2/14112

(57) ABSTRACT

A liquid ejection head comprises a liquid ejection substrate for ejecting a liquid, wherein the liquid ejection substrate includes a flow passage forming substrate and a support substrate which is bonded to the flow passage forming substrate via an adhesive, the flow passage forming substrate includes a common flow channel which communicates with a flow passage formed in the support substrate and an individual flow channel which communicates with the common flow channel, and among a corner portion of an end portion of the common flow channel, an angle of the corner portion which is closest to the individual flow channel is larger than 90°.

### BACKGROUND

### Field of the Disclosure

The disclosure relates to a liquid ejection head and a liquid ejection apparatus and particularly relates to a technique of laminating and bonding a plurality of substrates included in a liquid ejection head to each other.

### Description of the Related Art

There is a liquid ejection head which is formed by laminating a flow passage substrate, in which flow passages and the like for supplying a liquid such as an ink to ejection ports are formed, on a support substrate. Japanese Patent Laid-Open No. 2023-61022 describes bonding substrates to be laminated by using an adhesive. Specifically, squeeze-out of an adhesive from an adhesive portion is suppressed by controlling undulation of an adhesive layer in the case of transferring the adhesive layer onto a substrate.

However, in the case where there is even slight squeeze-out of an adhesive, the adhesive is squeezed out onto wall faces of partition walls which form the flow passages of the channel substrate or onto the support substrate. The adhesive creeps up particularly on a corner portion formed by two adjacent sides of the support substrate and the partition wall. In the case where the angle of the corner portion is an acute angle or a right angle, the adhesive is more likely to creep up on the corner portion due to capillary force attributable to surface tension of the adhesive. Then, in the case where the amount of the adhesive creeping up is large on the corner portion of the partition wall or the like of the channel substrate, an individual flow channel which communicates with a common flow channel formed in the channel substrate is clogged by the adhesive which has crept up, preventing a liquid from being supplied from the individual flow channel to an energy generating element, leading to a possibility that an adverse effect of impairing the liquid ejection performance of the liquid ejection head occurs.

### SUMMARY OF THE INVENTION

A liquid ejection head of the disclosure comprises: a liquid ejection substrate for ejecting a liquid, wherein the liquid ejection substrate includes a channel substrate and a support substrate which is bonded to the channel substrate via an adhesive, the channel substrate includes a common flow channel which communicates with a flow passage formed in the support substrate and an individual flow channel which communicates with the common flow channel, and among a corner portion of an end portion of the common flow channel, an angle of the corner portion which is closest to the individual flow channel is larger than 90°.

Further features of the disclosure will become apparent from the following description of exemplary embodiments with reference to the attached drawings.

### BRIEF DESCRIPTION OF THE DRAWINGS

FIG. 1 is a perspective view showing part of a liquid ejection substrate included in a liquid ejection head according to a first embodiment of the disclosure in section;

FIG. 2 is a sectional view of part of the liquid ejection substrate shown in FIG. 1;

FIG. 3 is a diagram of a channel substrate of the liquid ejection substrate shown in FIG. 1 as viewed from the lower face side;

FIG. 4 is an enlarged view of part A of FIG. 3;

FIG. 5 is an enlarged view of part B of FIG. 4;

FIG. 6 is a diagram for explaining a liquid ejection substrate according to a second embodiment of the disclosure;

FIG. 7 is an enlarged view of part C of FIG. 6;

FIG. 8 is a perspective view showing a liquid ejection head according to one embodiment of the disclosure; and

FIG. 9 is a perspective view schematically showing an inkjet printing apparatus according to one embodiment of a liquid ejection apparatus.

### DESCRIPTION OF THE EMBODIMENTS

Hereinafter, embodiments of the disclosure will be described in detail with reference to the drawings. However, the dimensions, materials, shapes, of the components of the embodiments described below, and relative arrangements thereof, and the like may be changed as appropriate in accordance with the configurations and various conditions of the liquid ejection substrate and the like of the liquid ejection head to which the disclosure is applied. The scope of the disclosure is not limited to the embodiments described below.

### Embodiment 1

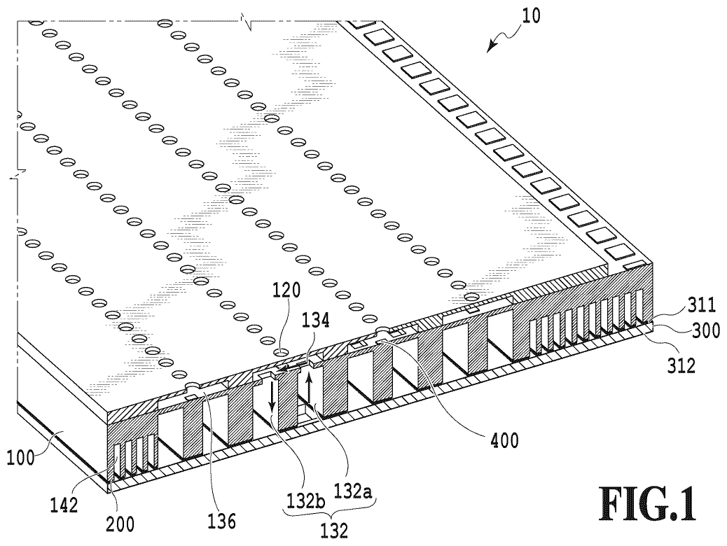

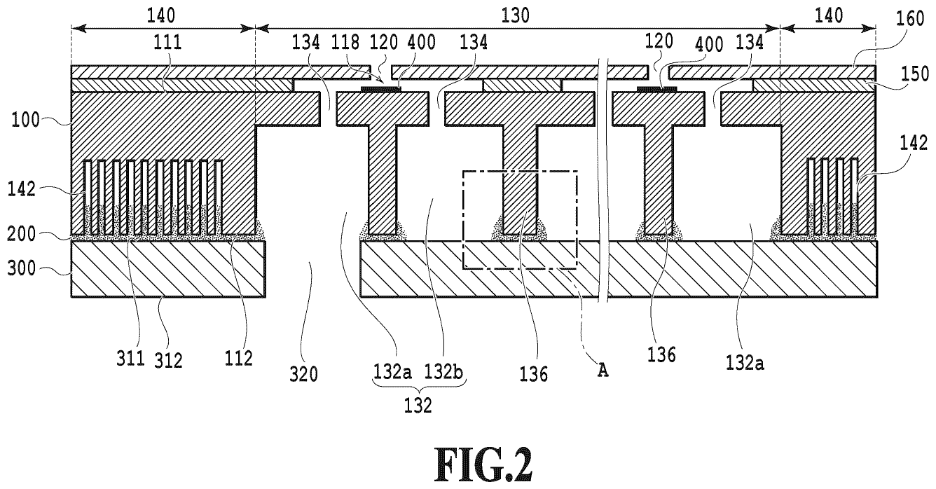

FIG. 1 is a perspective view showing part of a liquid ejection substrate included in a liquid ejection head according to the embodiment in section, and FIG. 2 is a sectional view of part of the liquid ejection substrate shown in FIG. 1. As shown in FIG. 1 and FIG. 2, a liquid ejection substrate 10 includes a channel substrate 100, a support substrate 300 which is bonded to the channel substrate 100 via an adhesive 200, and energy generating elements 400 which are provided on the channel substrate 100 and which are configured to generate energy used for ejecting a liquid.

The liquid ejection substrate 10 of the embodiment is mounted and used on an inkjet printing apparatus as a liquid ejection apparatus and ejects an ink as a liquid.

On an upper face 111 of the channel substrate 100, a flow passage layer 150 and a nozzle layer 160 are laminated in ranges corresponding to their forming portions to form ejection ports 120, pressure chambers 118, and the like. A lower face 112 of the channel substrate 100 is bonded to the support substrate 300 via the adhesive 200. In addition, in the support substrate 300, a pitch conversion flow passage 320 which is connected to a common flow channel 132 formed in the channel substrate 100 is formed.

The liquid ejection substrate 10 according to the embodiment as described above is divided into flow passage regions 130 and bonding regions 140 in a direction orthogonal to an array direction of the ejection ports 120 as shown in FIG. 2.

In the flow passage region 130, there are common flow channels 132 for supplying the liquid to the energy generating elements 400, individual flow channels 134 communicating with the common flow channels 132, and pressure chambers 118 provided with the energy generating elements 400. The liquid flows from the common flow channel 132 through the individual flow channel 134 to reach the pressure chamber 118, and the liquid which has reached the pressure chamber 118 is ejected from the ejection port 120, which communicate with the pressure chamber 118, by the energy generating element 400 generating the energy.

In addition, the common flow channel 132 includes a supply flow passage 132a for supplying the liquid to the energy generating element 400 and a collecting flow passage 132b for collecting the liquid which has been supplied to the energy generating element 400 but has not been used for ejection. As described above, the flow passage region 130 is a region in which the lower face 112 of a partition wall 136 for forming each flow passage is bonded to the support substrate 300 with the adhesive 200.

Referring to FIG. 1 and FIG. 2 again, the bonding region 140 is a region to which a flow passage is adjacent only on one side thereof in the channel substrate 100. That is, a portion in which the lower face 112 of the channel substrate 100 is bonded to the support substrate 300 in this region is a region in which the ink does not flow back and forth through this bonding portion. On the lower face 112 side of the channel substrate 100 in this region, a plurality of recesses (grooves) 142 which receive the adhesive 200 are provided.

Note that the energy generating element 400 of the embodiment is a heat generating resistive element, but may be in another configuration, and may be, for example, a piezoelectric element. In addition, wirings for supplying electric power to the energy generating elements 400, pads for electrode connection, and the like are not shown. For the adhesive 200, a material which has high adhesion to the channel substrate 100 and the support substrate 300 is favorably used, a material which is mixed with a small amount of bubbles and the like and has high coatability is preferable, and a low-viscosity material with which the thickness of the adhesive 200 can be easily reduced is preferable. For example, the adhesive 200 may contain any resin selected from the group consisting of epoxy resin, acrylic resin, silicone resin, benzocyclobutene resin, polyamide resin, polyimide resin, and urethane resin.

Moreover, the method for curing the adhesive 200 may be a thermosetting method or an ultraviolet-delayed curing method. Note that in the case where the channel substrate 100 or the support substrate 300 has an ultraviolet transmission property, an ultraviolet curing method can also be used as the method for curing the adhesive 200.

In addition, the method for applying the adhesive 200 includes an adhesive transfer method with a substrate to be used. Specifically, a transfer substrate is prepared, and the adhesive 200 is thinly and uniformly applied onto the transfer substrate by a spin coating method or a slit coating method. Thereafter, the lower face 112 of the channel substrate 100 is brought into contact with the adhesive 200 thus applied, so that the adhesive 200 can thus be transferred only to the lower face 112 of the channel substrate 100. The size of the transfer substrate is favorably equal to or larger than the dimensions of the channel substrate 100. As the transfer substrate, a film of silicon, glass, PET, PEN, PI, or the like is favorably used. In addition, the method for forming the adhesive 200 directly on the channel substrate 100 includes screen printing and dispense coating. Although the above description has been made by using the channel substrate 100, the adhesive 200 may be applied to a third face 311 of the support substrate 300 for bonding with the channel substrate 100 as the same coating method.

Note that the channel substrate 100 to which the adhesive 200 has been applied and the support substrate 300 are bonded by heating the channel substrate 100 and the support substrate 300 to a predetermined temperature and pressuring these with a predetermined time and pressure in a bonding apparatus. These bonding parameters are set as appropriate depending on the adhesive material. In addition, it is preferable to bond the channel substrate 100 and the support substrate 300 in vacuum in order to suppress mixing of bubbles into the bonding portion between the channel substrate 100 and the support substrate 300.

In the case where the adhesive 200 is of thermosetting type, the adhesive 200 may be heated until being cured inside the bonding apparatus. The curing of the adhesive 200 may be promoted by taking out the substrate-bonded product after bonding and then heating the substrate-bonded product separately with an oven. On the other hand, in the case where the adhesive 200 is of ultraviolet-delayed type, the adhesive 200 is irradiated with an ultraviolet ray in a defined amount in advance before the support substrate 300 is bonded to the channel substrate 100, and thereafter the support substrate 300 is bonded to the channel substrate 100. After the support substrate 300 is bonded to the channel substrate 100, it is preferable to further heat the substrate-bonded product to sufficiently promote the curing of the adhesive 200. In the case where the adhesive 200 is of ultraviolet curing type, after the channel substrate 100 and the support substrate 300 are bonded, the adhesive 200 is irradiated with an ultraviolet ray in a defined amount through a substrate (the channel substrate 100 or/and the support substrate 300) which has ultraviolet transmission property to cure the adhesive 200. After the support substrate 300 is bonded to the channel substrate 100, it is preferable to further heat the substrate-bonded product to sufficiently promote the curing of the adhesive 200.

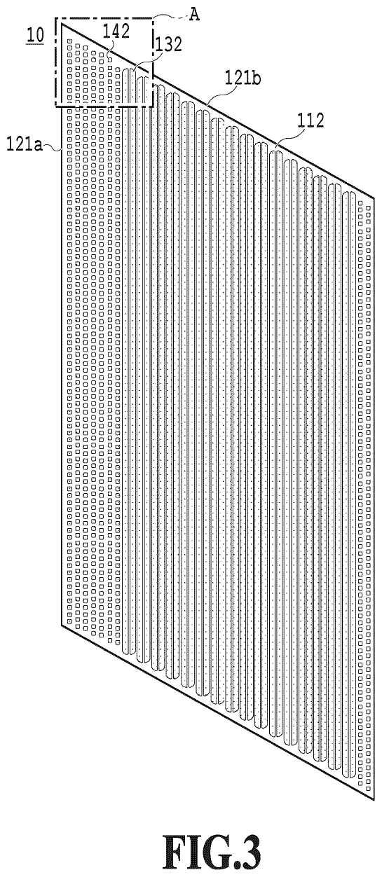

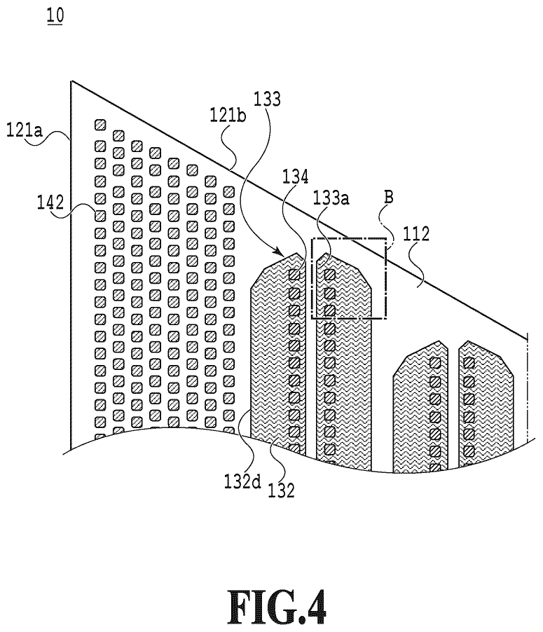

FIG. 3 is a diagram of the channel substrate 100 of the liquid ejection substrate 10 shown in FIG. 1 as viewed from the lower face side, and FIG. 4 is an enlarged view of part A of FIG. 3. As shown in FIG. 3 and FIG. 4, the common flow channels 132 extend substantially in parallel with a longitudinal end portion 121a of the channel substrate 100, and opening ends of the plurality of individual flow channels 134 are arrayed in parallel with the longitudinal direction of the common flow channels 132. In this way, each individual flow channel 134 is connected to and communicates with the corresponding common flow channel 132.

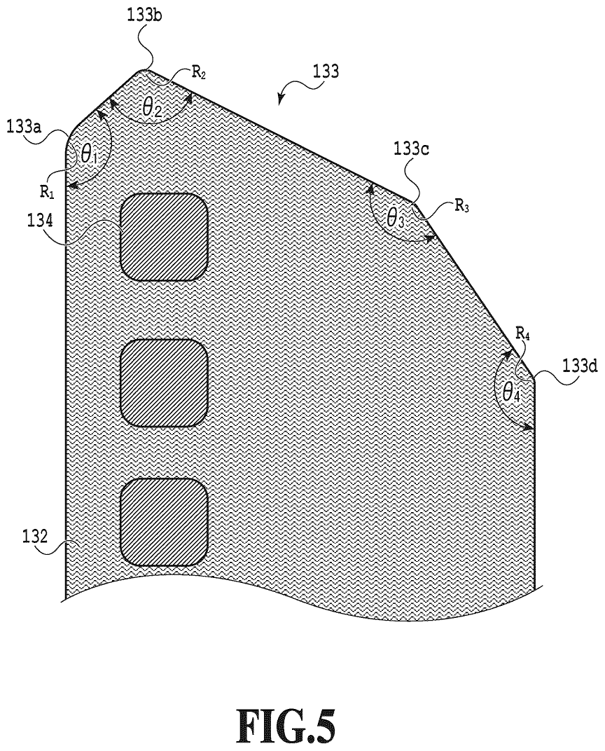

Each common flow channel 132 has four corner portions 133a, 133b, 133c, and 133d in an end portion 133 thereof (see FIG. 5). The corner portion in the present specification is a portion composed of inner wall faces of the common flow channel 320, which extends in a direction intersecting the bonding face of the channel substrate 100 to the support substrate 300. The corner portions 133a, 133b, 133c, and 133d are provided in two opposite end portions 133 of the common flow channel 132. Although the embodiment shows an example in which there are four corner portions 133a, 133b, 133c, and 133d in one end portion 133, it is preferable that four or more corner portions 133a, 133b, 133c, and 133d be provided and the number of corner portions is not limited to four.

FIG. 5 is a diagram showing part B of FIG. 4 in an enlarged manner. As shown in FIG. 5, in the liquid ejection head of the embodiment, in the case where the angles of the corner portions 133a, 133b, 133c, and 133d formed in the end portion 133 of the common flow channel 132 are represented respectively by θ₁, θ₂, θ₃, and θ₄, the angle θ₁ of the corner portion 133a which is closest to the individual flow channel 134 is set to be an angle larger than 90°. It can be also said that the angle θ₁ of the corner portion 133a in the planar shape of the common flow channel 132 is set to be an angle larger than 90° as viewed in a direction perpendicular to the bonding face of the channel substrate 100 to the support substrate 300. In the embodiment, the angles θ₂, θ₃, and θ₄ of the corner portions 133b, 133c, and 133d are also set to be angles larger than 90°. In addition, in the embodiment, two sides constituting each of the corner portions 133a, 133b, 133c, and 133d are connected by a curve to form the apex of the corner portion into a curved shape. In the case where the radii of curvature of the above curves of this curved shape are represented respectively by R₁, R₂, R₃, and R₄, these values correspond respectively to the above angles θ₁, θ₂, θ₃, and θ₄. For example, in the case where the angle θ₁ of the corner portion 133a which is closest to the individual flow channel 134 is largest, the radius of curvature R₁ also takes the largest value. With the above-described configuration of corner portions, when the channel substrate 100 is bonded to the support substrate 300 via the adhesive 200, the capillary force of the adhesive 200 is reduced, so that the creep-up of the adhesive 200 on the corner portions 133a, 133b, 133c, and 133d of the common flow channel 132 can be suppressed. In particular, the configuration in which the angle θ₁ of the corner portion 133a which is closest to the individual flow channel 134 is larger than 90° makes it possible to prevent the individual flow channel 134 which the adhesive 200 more easily reaches from being clogged by the adhesive 200.

Moreover, by providing the plurality of corner portions 133a, 133b, 133c, and 133d in the end portion 133 of the common flow channel 132, the creep-up of the adhesive 200 is dispersed to the corner portions 133a, 133b, 133c, and 133d when the channel substrate 100 is bonded to the support substrate 300 via the adhesive 200, so that the creep-up of the adhesive 200 into the corner portions 133a, 133b, 133c, and 133d due to the capillary force can be further suppressed, making it possible to obtain a liquid ejection substrate 10 which has no clogging in the individual flow channel 134 by the adhesive 200 and has a high yield.

Regarding the method for manufacturing the liquid ejection substrate 10 in the embodiment, the energy generating elements 400 which are utilized for ejecting a liquid and formed from TaSiN, an electric circuit (not shown) which drives the energy generating elements 400, and an electric connection portion (not shown) which is electrically connected to an electric connection substrate are disposed on the channel substrate 100. Specifically, the channel substrate 100 is formed of silicon and may be thinned to a substrate thickness of 625 μm by using a grinding apparatus.

In addition, the common flow channels 132 and the individual flow channels 134 for causing the liquid to flow therethrough and the recesses 142 for accommodating the adhesive 200 are formed in the channel substrate 100. Specifically, to form the recesses 142 for accommodating the adhesive 200 or the common flow channels 132 and individual flow channels 134 for causing the liquid to flow therethrough, anisotropic etching is conducted by the Bosch process, TMAH, KOH, or the like which is a type of reactive ion etching. The Bosch process can form etching grooves perpendicular to the channel substrate 100 by alternately conducting coating and etching. Moreover, non-through-holes may be formed and caused to penetrate by thinning the channel substrate 100 by back grinding or CMP.

Specifically, a resist is patterned from the lower face 112 of the channel substrate 100 by using the photolithography technique and is processed by dry etching using the Bosch process, and for example, when the common flow channels 132 are processed to a depth of 475 μm, the recesses 142 can be processed to a depth of 250 to 300 μm. The reason that the recesses 142 are shallower than the common flow channels 132 is influence of micro-loading effect attributable to difference in opening areas. In addition, the recesses 142 can be formed by patterning and etching at the same time as the common flow channels 132. In the case of individually adjusting the capacity of the recesses 142, the common flow channels 132 and the recesses 142 can be patterned and etched separately.

Similarly, the individual flow channels 134 are processed from the upper face 111 of the channel substrate 100 to cause the common flow channels 132 and the individual flow channels 134 to communicate with each other.

The support substrate 300 is formed of silicon, and the thickness of the support substrate 300 is 725 μm. A resist is patterned from a fourth face 312 opposite to the third face 311 which is bonded to the channel substrate 100 by using the photolithography technique in the same manner as the channel substrate 100, and non-through-holes are processed to a depth of 320 μm by dry etching using the Bosch process. Thereafter, the substrate is thinned to 300 μm from the third face 311 by back grinding or CMP to cause the non-through-holes to penetrate, so that the pitch conversion flow passages 320 which are connected to the common flow channels 132 are formed.

Next, an adhesive transfer substrate is prepared, and is spin-coated with a benzocyclobutene solution as the adhesive 200 to a thickness of 7 μm. A PET film is used as the transfer substrate. In addition, to vaporize the solvent after the coating, a baking process is conducted at 100° C. for 5 minutes. By bringing, while heating, the adhesive formed on the transfer substrate into contact with the lower face 112 of the channel substrate 100, the adhesive 200 is transferred to the channel substrate 100. The thickness after the transfer to the channel substrate 100 is 2.5 μm.

In addition, the channel substrate 100 and the support substrate 300 are heated in vacuum to be bonded while being aligned with each other by using a bonding alignment apparatus. For example, the bonding may be conducted at a degree of vacuum of 100 Pa or less and at a temperature of 150° C. When the squeeze-out of the adhesive into the common flow channels 132 after the bonding has been checked, the thickness of the squeeze-out of the adhesive on the partition walls 136 forming the common flow channels 132 is a thickness similar to or smaller than the thickness of the other squeeze-out of the adhesive in the common flow channels 132.

After bonding and cooling, the channel substrate 100 and the support substrate 300 are taken out from the apparatus, followed by conducting heat treatment at 250° C. for 1 hour in an oven in nitrogen atmosphere to cure the adhesive.

Next, a PET film is spin-coated with a solution obtained by dissolving a negative photosensitive resin in a PGMEA solvent, and is dried at 100° C. in an oven into a dry film. This dry film is transferred onto the upper face 111 of the channel substrate 100, and the PET film is peeled off to form a photosensitive resin layer. The photosensitive resin layer is exposed to a pattern which will be flow passages, and thereafter, PEB is conducted to form a state of latent image. Subsequently, a dry film is similarly laminated and is exposed to a pattern which will be nozzles, and thereafter, PEB is conducted to simultaneously develop the flow passages and the nozzles, so that a wafer for liquid ejection head is completed.

Stealth dicing using laser is conducted on the wafer for liquid ejection head to form a plurality of modified layers inside the silicon substrate in the thickness direction of the substrate (the channel substrate 100 or the support substrate 300). External force is applied to the wafer, thereby causing cracks to proceed between the modified portion and the modified portion to separate the wafer, so that the liquid ejection substrate can be obtained.

### Embodiment 2

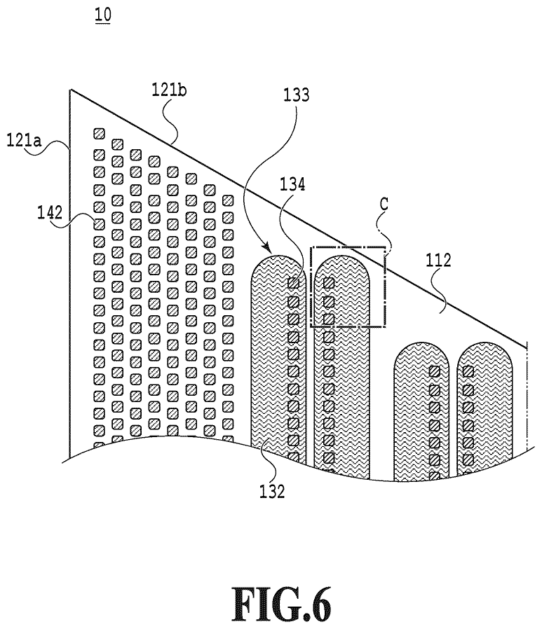

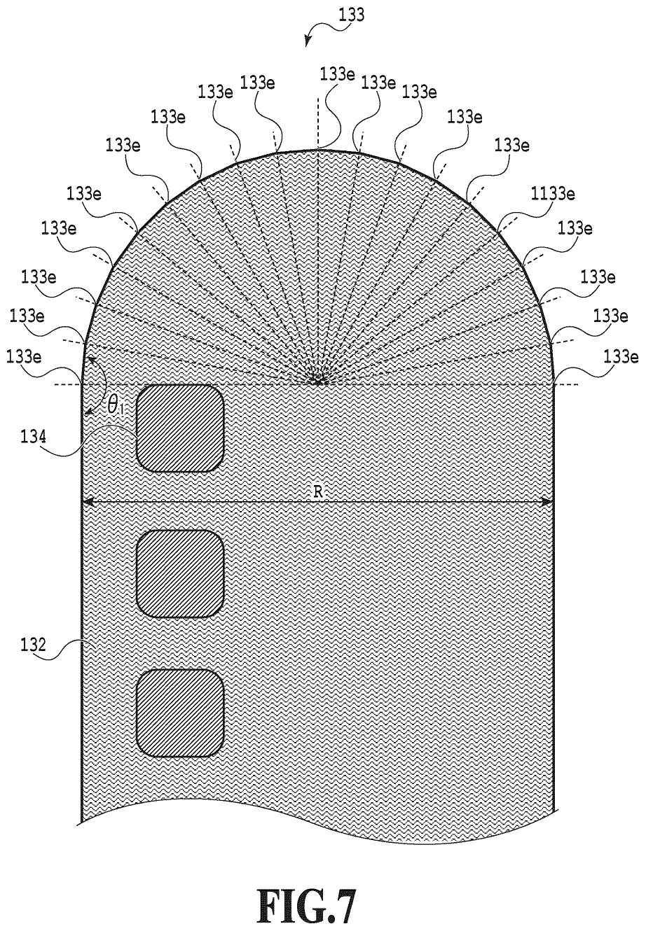

FIG. 6 is a diagram showing a liquid ejection substrate according to a second embodiment of the disclosure, and shows the liquid ejection substrate from the support substrate side while the support substrate is omitted. FIG. 7 is an enlarged view of part C of FIG. 6. As shown in FIG. 6 and FIG. 7, corner portions 133e provided in an end portion 133 of a common flow channel 132 are disposed on a circumference having a diameter equal to the width R of the common flow channel 132. Specifically, in the end portion 133 of the common flow channel 132 of the embodiment, 19 corner portions 133e are provided, and the corner portions 133e are disposed at equal intervals. Hence, an angle of each corner portion 133e is larger than 90°. In this way, the end portion 133 takes a substantially semi-circular shape. Then, each corner portion 133e is formed with an angle larger than 90°, which makes it possible to prevent the adhesive 200 from creeping up on the corner portions 133e and disperse the creeping up when the channel substrate 100 is bonded to the support substrate 300 via the adhesive 200. As a result, the creep-up of the adhesive 200 due to surface tension in the corner portions 133e can be further suppressed, making it possible to obtain a liquid ejection substrate 10 which has no clogging by the adhesive 200 in the individual flow channel 134 and has a high yield.

In addition, in the embodiment, the angle θ₁ of the corner portion 133e which is closest to the individual flow channel 134 is 170°.

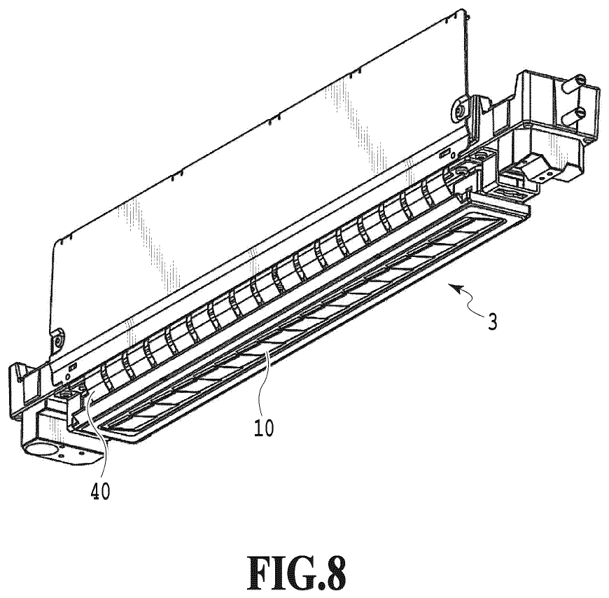

FIG. 8 is a perspective view showing a liquid ejection head according to one embodiment of the disclosure. As shown in FIG. 8, a liquid ejection head 3 is formed by bonding a plurality of liquid ejection substrates 10 each having the above-mentioned configuration. Specifically, the liquid ejection head 3 is a line-type liquid ejection head in which 17 liquid ejection substrates 10 each capable of ejecting an ink are arrayed in a straight line (in line). The liquid ejection head 3 includes a signal input terminal and a power supply terminal which are electrically connected to each liquid ejection substrate 10 via the flexible wiring substrate 40 or the like.

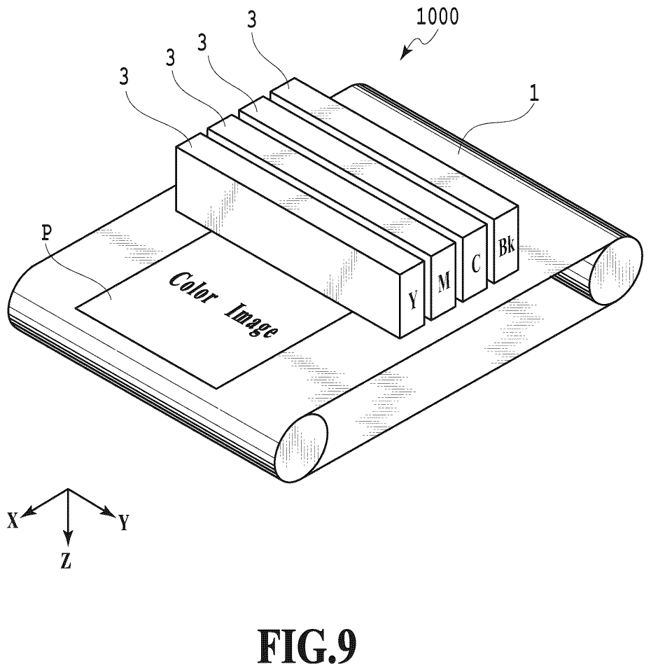

FIG. 9 is a perspective view schematically showing an inkjet printing apparatus according to one embodiment of the liquid ejection apparatus. The inkjet printing apparatus 1000 includes liquid ejection heads 3 which eject inks of cyan (C), magenta (M), yellow (Y), and black (Bk), respectively. The printing apparatus 1000 prints an image on a printing medium P by ejecting the inks from these liquid ejection heads 3 onto the printing medium P in accordance with print data. In FIG. 9, the X direction is a conveyance direction of the printing medium P, the Y direction is a width direction of the printing medium P, and the Z direction is a vertical upper direction.

Note that the liquid ejection apparatus is not limited to a printing apparatus as mentioned above. The liquid ejection apparatus may be, for example, a single-function printer having only a printing function or may be a multi-function printer having a plurality of functions such as a printing function, a FAX function, and a scanner function. In addition, the liquid ejection apparatus may be a manufacturing apparatus for manufacturing a color filter, an electronic device, an optical device, a micro structure, or the like in accordance with a predetermined printing method or a fine bubble generating apparatus, or the like.

According to the above configuration, it is possible to suppress the creep-up of an adhesive into a corner portion of a common flow channel due to capillary force attributable to surface tension of the adhesive in the corner portion and to prevent an individual flow channel from being clogged by the adhesive in a liquid ejection head when a channel substrate is bonded to a support substrate via the adhesive.

### OTHER EMBODIMENTS

Regarding the above-mentioned first to second embodiment, it is obvious also from the above description that any combinations of these embodiments are encompassed by the embodiments of the disclosure unless such combinations are inconsistent with the gist of the disclosure.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-140802, filed Aug. 31, 2023, which is hereby incorporated by reference wherein in its entirety.

What is claimed is:

1. A liquid ejection head comprising:
a liquid ejection substrate for ejecting a liquid, wherein
the liquid ejection substrate includes a channel substrate and a support substrate which is bonded to the flow passage forming substrate via an adhesive,
the flow passage forming substrate includes a common flow channel which communicates with a flow passage formed in the support substrate and an individual flow channel which communicates with the common flow channel, and
among a corner portion of an end portion of the common flow channel, an angle of the corner portion which is closest to the individual flow channel is larger than 90°.

2. The liquid ejection head according to claim 1, wherein
one of the end portion includes four or more of the corner portions.

3. The liquid ejection head according to claim 2, wherein
each of the four or more corner portions has a curved shape, and
among the four or more corner portions, a radius of curvature of the corner portion which is closest to the individual flow channel has a largest value.

4. The liquid ejection head according to claim 1, wherein
in the end portion of the common flow channel, the corner portion is disposed on a circumference having a diameter equal to a width of the common flow channel.

5. The liquid ejection head according to claim 4, wherein
one of the end portion includes a plurality of the corner portions, and
the plurality of corner portions are disposed at equal intervals.

6. The liquid ejection head according to claim 1, wherein
as viewed from a direction perpendicular to a surface of the liquid ejection substrate, an angle of the corner portion which is closest to the individual flow channel is larger than 90°.

7. The liquid ejection head according to claim 1, wherein
the common flow channel communicates with a plurality of the individual flow channels.

8. The liquid ejection head according to claim 7, wherein
the plurality of individual flow channels are arrayed in parallel with a longitudinal direction of the common flow channel.

9. The liquid ejection head according to claim 8, wherein
in a direction orthogonal to the longitudinal direction of the common flow channel, a center of the common flow channel and a center of each individual flow channel are misaligned from each other.

10. A liquid ejection apparatus comprising:
a liquid ejection head including a liquid ejection substrate for ejecting a liquid, in which
the liquid ejection substrate includes a flow passage forming substrate and a support substrate which is bonded to the flow passage forming substrate via an adhesive,
the flow passage forming substrate includes a common flow channel which communicates with a flow passage formed in the support substrate and an individual flow channel which communicates with the common flow channel, and
among a corner portion of an end portion of the common flow channel, an angle of the corner portion which is closest to the individual flow channel is larger than 90°, wherein
the liquid ejection apparatus prints by ejecting an ink from the liquid ejection head onto a printing medium.
